(19) United States
(12) Patent Application Publication
(10) Pub. No.: US 2017/0190938 A1
(43) Pub. Date: Jul. 6, 2017

(54) SEAL AGENT, DISPLAY PANEL AND DISPLAY DEVICE

(71) Applicants: Boe Technology Group Co., Ltd., Beijing (CN); Beijing Boe Optoelectronics Technology Co., Ltd., Beijing (CN)

(72) Inventor: Hongpeng Li, Beijing (CN)

(21) Appl. No.: 15/229,380

(22) Filed: Aug. 5, 2016

(30) Foreign Application Priority Data
Jan. 5, 2016 (CN) 201610007050.1

(51) Int. Cl. C09J 4/06; B32B 7/12; G02F 1/1339

(52) U.S. Cl. CPC C09J 4/06; G02F 1/1339; B32B 7/12; B32B 2457/20

(57) ABSTRACT

The present invention relates to the field of display manufacture technologies and discloses a seal agent, a display panel and a display device, wherein the material of the seal agent comprises: 30 to 40 parts by weight of an ultraviolet double bond polymerizable monomer; 20 to 30 parts by weight of a rigid double bond polymerizable monomer; 1 to 5 parts by weight of a photoinitiator having an absorption peak ranging from 370 to 400 nm; 10 to 20 parts by weight of an E51 epoxy resin; 5 to 15 parts by weight of a thermal curing agent; and 10 to 20 parts by weight of granules.

### RELATED APPLICATION

The present application claims the benefit of the preceding Chinese Patent Application No. 201610007050.1, filed on Jan. 5, 2016, the entire disclosure of which is incorporated herein by reference.

### TECHNICAL FIELD

The present invention relates to the field of displayer manufacture technologies, and particularly to a seal agent, a display panel and a display device.

### BACKGROUND

The in-vehicle liquid crystal display device (e.g. TFT-LCD, Thin Film Transistor-Liquid Crystal Device) is widely used in recent years due to its advantages including convenience, security and functionality. However, the in-vehicle display panel has a higher requirement on reliability as compared to the traditional display panel for mobile products. For example, since the vehicles bump during the driving process, the color film substrate and the array substrate of the manufactured display panel are likely to slide with respect to each other, affecting the display effect of the display panel. Since the temperature of the in-vehicle product is high when used in the summer, and the picture is relatively fixed, there is a higher requirement on the sticking image of the product. Accordingly, only a seal agent material with high adhesive force and low pollution can meet the requirement on the reliability of the in-vehicle product.

As shown in FIG. 1, during the process of manufacturing a liquid crystal panel, i.e. at the time of performing cell-assembling process, it is required to coat a seal agent 1 on one of the glass substrates. The adhesion of an array substrate 2 to a color film substrate 3 is enabled in vacuum state using a high-precision alignment device. The thickness of cell is usually maintained by adding glass fibers or silica spheres to the seal agent 1. Obviously, the seal agent for adhering the upper substrate to the lower substrate and sealing the liquid crystal is a crucial material in the liquid crystal panel cell-assembling process. The common seal agent is crosslinked by means of stepwise polymerization, that is, ultraviolet polymerization is performed firstly, and then thermal polymerization is performed. At the first stage, the ultraviolet radiation enables the photoinitiator to generate free radicals. The free radicals cause chain polymerization of ultraviolet double bond polymerizable monomers to generate polymers having a two-dimensional structure and rarely a three-dimensional structure. Subsequently, at the second stage, the seal agent 1 is completely cured by thermosetting to form final three-dimensional polymers. During the whole curing process, the reaction rate at the first stage significantly impacts on the yield and the picture quality of the final product. If the curing rate at the UV light stage is high, the ingredients in the seal agent that pollute the liquid crystal during the second stage of thermosetting would be reduced, which would accordingly improve the sticking image level of the product. In addition, since the curing rate at the UV light stage is increased, the adhesive force and the rigidity of the seal agent after curing are enhanced, moveable “zara” generated in the display panel during the subsequent polishing process is also reduced. Here, the zara indicates small bright spots. However, these small bright spots would flow with the liquid crystal in the course of pressing the panel, and are hence called moveable zara.

In the existing seal agent products, in order to ensure the reaction rate at the UV light stage, more photoinitiators (about 10 to 15 parts by weight, which is 8% higher than the theoretically calculated value) are usually added to the composition of the seal agent. Although the conversion rate of the acrylic resin in the seal agent can be improved in this manner, after the end of the UV light reaction, the small-molecular photoinitiator that remains in the seal agent would not only deteriorate the mechanical properties of the seal agent material, but also be likely to dissolve out during the thermosetting process and consequently pollute the liquid crystal, resulting in occurrence of the phenomena such as high incidence of moveable zara and poor sticking image level in the display panel. Accordingly, the adhesive force of the seal agent would also decrease, and there is a risk in performing reliability stripping test for the display panel.

### SUMMARY

Embodiments of the present invention provide a seal agent, a display panel and a display device for reducing the incidence of the phenomenon of moveable zara resulting from polishing of the display device and for enhancing the adhesive force of the seal agent.

In a first aspect, embodiments of the present invention provide a seal agent made of a material comprising: 30 to 40 parts by weight of an ultraviolet double bond polymerizable monomer; 20 to 30 parts by weight of a rigid double bond polymerizable monomer; 1 to 5 parts by weight of a photoinitiator having an absorption peak ranging from 370 to 400 nm; 10 to 20 parts by weight of an E51 epoxy resin; 5 to 15 parts by weight of a thermal curing agent; and 10 to 20 parts by weight of granules.

The seal agent provided by embodiments of the present invention can reduce the incidence of moveable zara resulting from polishing of the display device by using the rigid double bond polymerizable monomer, can improve the utilization rate of the UV light of an ultraviolet device during the process of manufacturing the display panel by using the photoinitiator having an absorption peak ranging from 370 to 400 nm, can facilitate the double bond reaction within the composition of the seal agent, can reduce the parts by weight of the photoinitiator to reduce the incidence of the phenomenon that the small-molecular photoinitiator that remains in the seal agent causes deterioration in the mechanical properties of the seal agent material, and can also reduce the incidence of the phenomenon that the small-molecular photoinitiator that remains in the seal agent dissolves out during the thermosetting process and consequently pollutes the liquid crystal. In addition, since the parts by weight of the photoinitiator are reduced, the parts by weight of the epoxy resin can be correspondingly increased to enhance the adhesive force of the seal agent.

In some alternative embodiments, the rigid double bond polymerizable monomer has a structural formula as shown in Formula I:

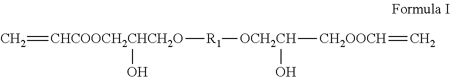

wherein R₁ is an aromatic alkane group.

In some alternative embodiments, the aromatic alkane group has a structural formula as shown in Formula II:

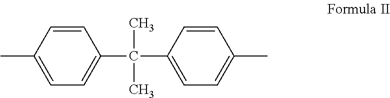

In some alternative embodiments, the ultraviolet double bond polymerizable monomer has a structural formula as shown in Formula III:

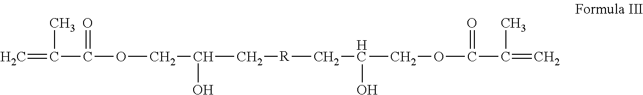

wherein R is substitutable or unsubstitutable alkyl, and the number of carbon atoms of the alkyl is 5 to 15.

In some alternative embodiments, the substitutable alkyl includes either of hydroxyl-substituted alkyl and carbonyl-substituted alkyl.

In some alternative embodiments, the photoinitiator includes at least one of (2,4,6-trimethylbenzoyl)phosphine oxide and a,a-dimethyl benzil ketal.

In some alternative embodiments, the thermal curing agent includes at least one of 3,5-dimethylaniline and tetramethylaniline.

In some alternative embodiments, the granules include at least one of organic elastic pellets and silica pellets, wherein the organic elastic pellets have a diameter at nanoscale, and the silica pellets have a diameter ranging from 0.5 to 1.5 μm.

In some alternative embodiments, the material comprises: 30 parts by weight of an ultraviolet double bond polymerizable monomer; 20 parts by weight of a rigid double bond polymerizable monomer; 1 part by weight of a photoinitiator having an absorption peak of 370 nm; 10 parts by weight of an E51 epoxy resin; 5 parts by weight of a thermal curing agent; 10 parts by weight of granules.

In some alternative embodiments, the material comprises: 35 parts by weight of an ultraviolet double bond polymerizable monomer; 25 parts by weight of a rigid double bond polymerizable monomer; 3 parts by weight of a photoinitiator having an absorption peak of 380 nm; 20 parts by weight of an E51 epoxy resin; 15 parts by weight of a thermal curing agent; 20 parts by weight of granules.

In some alternative embodiments, the material comprises: 40 parts by weight of an ultraviolet double bond polymerizable monomer; 30 parts by weight of a rigid double bond polymerizable monomer; 3 parts by weight of a photoinitiator having an absorption peak of 400 nm; 20 parts by weight of an E51 epoxy resin; 15 parts by weight of a thermal curing agent; 20 parts by weight of granules.

In some alternative embodiments, the material comprises: 33 parts by weight of an ultraviolet double bond polymerizable monomer; 23 parts by weight of a rigid double bond polymerizable monomer; 4 parts by weight of a photoinitiator having an absorption peak of 380 nm; 13 parts by weight of an E51 epoxy resin; 8 parts by weight of a thermal curing agent; 13 parts by weight of granules.

In some alternative embodiments, the material comprises: 38 parts by weight of an ultraviolet double bond polymerizable monomer; 28 parts by weight of a rigid double bond polymerizable monomer; 6 parts by weight of a photoinitiator having an absorption peak of 390 nm; 18 parts by weight of an E51 epoxy resin; 12 parts by weight of a thermal curing agent; 15 parts by weight of granules.

In a second aspect, embodiments of the present invention provide a display panel comprising a first substrate and a second substrate arranged opposite to each other, and further comprising the seal agent as described above arranged between the first substrate and the second substrate. Since the above seal agent has good adhesive property, it can reduce the incidence of the phenomenon of moveable zara after polishing of the display device. Accordingly, the display panel provided by the present invention has good display effect.

In a third aspect, embodiments of the present invention further provide a display device comprising the above display panel. The display device has good display effect.

### BRIEF DESCRIPTION OF THE DRAWINGS

FIG. 1 shows a substantial structural schematic diagram of a display panel having a seal agent.

### DETAILED DESCRIPTION

Specific embodiments of the present invention are set forth below in detail with reference to the drawings. It should be understood that the specific embodiments described here are only used for exemplifying and interpreting the present invention, rather than limiting the present invention.

It is firstly to be noted that the parts of respective components by weight in the composition can specifically be represented by the form of weight fractions. The weight fraction of one component is the weight percent of the component in the composition.

Embodiments of the present invention provide a seal agent comprising: 30 to 40 parts by weight of an ultraviolet double bond polymerizable monomer; 20 to 30 parts by weight of a rigid double bond polymerizable monomer; 1 to 5 parts by weight of a photoinitiator having an absorption peak of 370 to 400 nm; 10 to 20 parts by weight of an E51 epoxy resin; 5 to 15 parts by weight of a thermal curing agent; and 10 to 20 parts by weight of granules.

The above seal agent can reduce the incidence of moveable zara resulting from polishing of the display device by using the rigid double bond polymerizable monomer, can improve the utilization rate of the UV light of an ultraviolet device during the process of manufacturing the display panel by using the photoinitiator having an absorption peak ranging from 370 to 400 nm, can facilitate the double bond reaction within the composition of the seal agent, can reduce the parts by weight of the photoinitiator to reduce the incidence of the phenomenon that the small-molecular photoinitiator that remains in the seal agent causes deterioration in the mechanical properties of the seal agent material, and can also reduce the incidence of the phenomenon that the small-molecular photoinitiator that remains in the seal agent dissolves out during the thermosetting process and consequently pollutes the liquid crystal. In addition, since the parts by weight of the photoinitiator are reduced, the parts by weight of the epoxy resin can be correspondingly increased to enhance the adhesive force of the seal agent.

After performing the polishing experiment for a plurality of display panels having the seal agent provided by embodiments of the present invention and a plurality of display panels having the prior art seal agent, respectively, the incidences of moveable zara in the display panel are shown in Table 1 as follows:

TABLE 1

| | Incidence of moveable | Incidence of moveable zara in |
|---|---|---|
| | zara in display | display panels having the seal |
| | panels having the | agent of embodiments of the |
| | traditional seal agent | present invention |
| No polishing | 0 | 0 |
| Polishing for 10 | 4% | 0 |
| minutes | | |
| Polishing for 15 | 64%, and 100% after | 0 |
| minutes | recheck | |

It can be seen from the comparison results of Table 1 that the seal agent provided by the present invention can significantly reduce the incidence of moveable zara during the subsequent polishing process of the display panel.

The results of sticking image verification performed for the display panels having the seal agent provided by embodiments of the present invention and the display panels having the prior art seal agent are shown in Table 2 as follows, wherein more black blocks in Table 2 indicate lower sticking image level of the display panel.

The reliability stripping test is performed for display panels having the seal agent provided by embodiments of the present invention and seal agents having the prior art seal agent, respectively. The test results are shown in Table 3 as follows:

TABLE 3

| | | | | | | | |
|---|---|---|---|---|---|---|---|
| Lower | | Lower | | Upper | | Upper | |
| left | kgf | right | kgf | left | kgf | right | kgf |

Sample type: display panels having
the seal agent provided by embodiments of the present invention

| | | | | | | | |
|---|---|---|---|---|---|---|---|
| #1 | 26.23 | #1 | 26.52 | #1 | 23.67 | #1 | 26.64 |
| #2 | 26.64 | #2 | 26.37 | #2 | 25.89 | #2 | 26.74 |
| #3 | 24.97 | #3 | 26.55 | #3 | 25.1 | #3 | 25.31 |
| #4 | 25.6 | #4 | 26.95 | #4 | 26.37 | #4 | 26.61 |
| #5 | 26.87 | #5 | 25.67 | #5 | 26.4 | #5 | 26.92 |

Sample type: display panels having the prior art seal agent

| | | | | | | | |
|---|---|---|---|---|---|---|---|
| #1 | 15.3 | #1 | 15.32 | #1 | 16.08 | #1 | 15.36 |
| #2 | 15.23 | #2 | 15.69 | #2 | 17.01 | #2 | 15.97 |
| #3 | 18.11 | #3 | 15.73 | #3 | 15.96 | #3 | 15.66 |
| #4 | 14.98 | #4 | 18.01 | #4 | 15.98 | #4 | 15.83 |
| #5 | 17.62 | #5 | 17.31 | #5 | 15.63 | #5 | 16.09 |

It can be seen from Tables 1, 2 and 3 that the seal agent provided by embodiments of the present invention can raise the sticking image level of the display panel from L2-L3 to a level close to L0, and the adhesive force of the seal agent provided by embodiments of the present invention is raised from 15 kgf (kilogram-force) to about 25 kgf (kilogram-force).

The seal agent provided by embodiments of the present invention may have many kinds of compositions. Several schemes for the composition of the seal agent are introduced specifically below in accordance with several embodiments.

### Embodiment 1

The seal agent provided by this embodiment comprises 30 parts by weight of an ultraviolet double bond polymerizable monomer; 20 parts by weight of a rigid double bond polymerizable monomer; 1 part by weight of a photoinitiator having an absorption peak of 370 nm; 10 parts by weight of an E51 epoxy resin; 5 parts by weight of a thermal curing agent; 10 parts by weight of granules.

### Embodiment 2

The seal agent provided by this embodiment comprises 35 parts by weight of an ultraviolet double bond polymerizable monomer; 25 parts by weight of a rigid double bond polymerizable monomer; 3 parts by weight of a photoinitiator having an absorption peak of 380 nm; 20 parts by weight of an E51 epoxy resin; 15 parts by weight of a thermal curing agent; 20 parts by weight of granules.

### Embodiment 3

The seal agent provided by this embodiment comprises 40 parts by weight of an ultraviolet double bond polymerizable monomer; 30 parts by weight of a rigid double bond polymerizable monomer; 3 parts by weight of a photoinitiator having an absorption peak of 400 nm; 20 parts by weight of an E51 epoxy resin; 15 parts by weight of a thermal curing agent; 20 parts by weight of granules.

### Embodiment 4

The seal agent provided by this embodiment comprises 33 parts by weight of an ultraviolet double bond polymerizable monomer; 23 parts by weight of a rigid double bond polymerizable monomer; 4 parts by weight of a photoinitiator having an absorption peak of 380 nm; 13 parts by weight of an E51 epoxy resin; 8 parts by weight of a thermal curing agent; 13 parts by weight of granules.

### Embodiment 5

The seal agent provided by this embodiment comprises 38 parts by weight of an ultraviolet double bond polymerizable monomer; 28 parts by weight of a rigid double bond polymerizable monomer; 6 parts by weight of a photoinitiator having an absorption peak of 390 nm; 18 parts by weight of an E51 epoxy resin; 12 parts by weight of a thermal curing agent; 15 parts by weight of granules.

In any of the above embodiments, the rigid double bond polymerizable monomer has a structural formula as shown in Formula I:

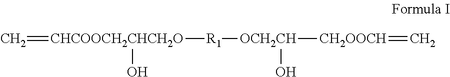

wherein R₁ is is an aromatic alkane group.

Alternatively, the aromatic alkane group has a structural formula as shown in Formula II:

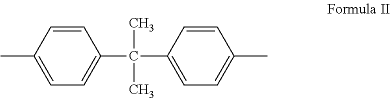

In any of the above embodiments, the ultraviolet double bond polymerizable monomer has a structural formula as shown in Formula III:

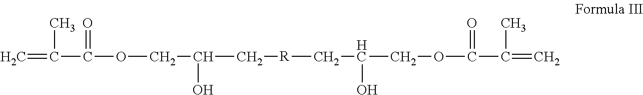

wherein R is substitutable or unsubstitutable alkyl, and the number of carbon atoms of the alkyl is 5 to 15.

Alternatively, the substitutable alkyl includes either of hydroxyl-substituted alkyl and carbonyl-substituted alkyl.

The photoinitiator in any of the above embodiments includes at least one of (2,4,6-trimethylbenzoyl)phosphine oxide and a,a-dimethyl benzil ketal.

The thermal curing agent in any of the above embodiments includes at least one of 3,5-dimethylaniline and tetramethylaniline.

The granules in any of the above embodiments include at least one of organic elastic pellets and silica pellets, wherein the organic elastic pellets have a diameter at nanoscale, and the silica pellets have a diameter ranging from 0.5 to 1.5 μm.

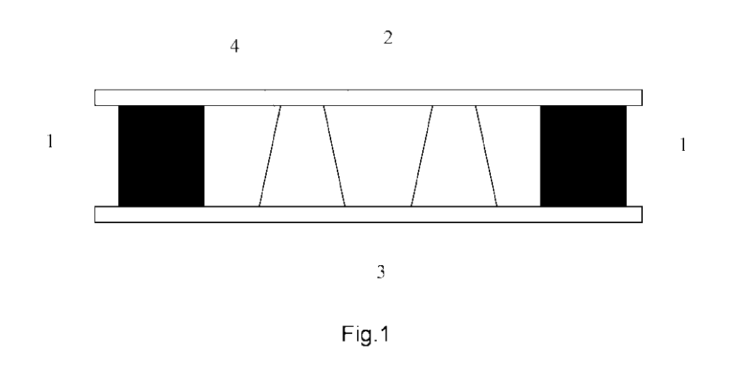

On the basis of the advantages of the above seal agent, embodiments of the present invention further provide a display panel comprising a first substrate 2 and a second substrate 3 arranged opposite to each other, and further comprising the seal agent 1 as described above arranged between the first substrate 2 and the second substrate 3. Besides, there are spacers 4 between the first substrate 2 and the second substrate 3. Since the above seal agent has good adhesive property, it can reduce the incidence of the phenomenon of moveable zara resulting from polishing of the display device. Accordingly, the display panel provided by the present invention has good display effect. The seal agent 1 can be arranged in the display panel as shown in FIG. 1.

The above first substrate is a color film substrate and the second substrate is an array substrate, or the first substrate is an array substrate and the second substrate is a color film substrate.

Embodiments of the present invention further provide a display device comprising the above display panel, which has good display effect.

The display device may be any product or component having display function such as computer display screen, electronic paper, liquid crystal display, liquid crystal television, digital frame, mobile phone, tablet computer, and so on.

Obviously, those skilled in the art can make various modifications and variations to the present invention without departing from the spirit and scope thereof. In this way, if these modifications and variations to the present invention pertain to the scope of the claims of the present disclosure and equivalent technologies thereof, the present invention also intends to encompass these modifications and variations.

1. A seal agent made of a material comprising:
30 to 40 parts by weight of an ultraviolet double bond polymerizable monomer;
20 to 30 parts by weight of a rigid double bond polymerizable monomer;
1 to 5 parts by weight of a photoinitiator having an absorption peak ranging from 370 to 400 nm;
10 to 20 parts by weight of an E51 epoxy resin;
5 to 15 parts by weight of a thermal curing agent; and
10 to 20 parts by weight of granules.

2. The seal agent according to claim 1, therein the rigid double bond polymerizable monomer has a structural formula as shown in Formula I: 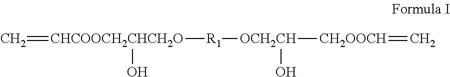
wherein R₁ is an aromatic alkane group.

3. The seal agent according to claim 2, wherein the aromatic alkane group has a structural formula as shown in Formula II:

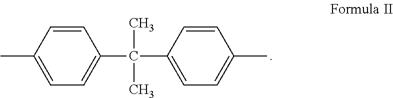

4. The seal agent according to claim 1, wherein the ultraviolet double bond polymerizable monomer has a structural formula as shown in Formula III: 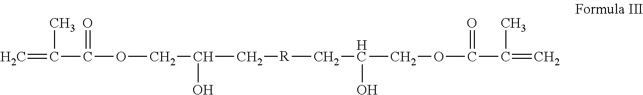
wherein R is substitutable or unsubstitutable alkyl, and a number of carbon atoms of the alkyl is 5 to 15.

5. The seal agent according to claim 4, wherein the substitutable alkyl includes either of hydroxyl-substituted alkyl and carbonyl-substituted alkyl.

6. The seal agent according to claim 1, wherein the photoinitiator includes at least one of (2,4,6-trimethylbenzoyl)phosphine oxide and a,a-dimethyl benzil ketal.

7. The seal agent according to claim 1, wherein the thermal curing agent includes at least one of 3,5-dimethylaniline and tetramethylaniline.

8. The seal agent according to claim 1, wherein the granules include at least one of organic elastic pellets and silica pellets, wherein the organic elastic pellets have a diameter at nanoscale, the silica pellets have a diameter ranging from 0.5 to 1.5 μm.

9. The seal agent according to claim 1, wherein the material comprises:
30 parts by weight of an ultraviolet double bond polymerizable monomer; 20 parts by weight of a rigid double bond polymerizable monomer; 1 part by weight of a photoinitiator having an absorption peak of 370 nm; 10 parts by weight of an E51 epoxy resin; 5 parts by weight of a thermal curing agent; 10 parts by weight of granules.

10. The seal agent according to claim 1, wherein the material comprises:
35 parts by weight of an ultraviolet double bond polymerizable monomer; 25 parts by weight of a rigid double bond polymerizable monomer; 3 parts by weight of a photoinitiator having an absorption peak of 380 nm; 20 parts by weight of an E51 epoxy resin; 15 parts by weight of a thermal curing agent; 20 parts by weight of granules.

11. The seal agent according to claim 1, wherein the material comprises:
40 parts by weight of an ultraviolet double bond polymerizable monomer; 30 parts by weight of a rigid double bond polymerizable monomer; 3 parts by weight of a photoinitiator having an absorption peak of 400 nm; 20 parts by weight of an E51 epoxy resin; 15 parts by weight of a thermal curing agent; 20 parts by weight of granules.

12. The seal agent according to claim 1, wherein the material comprises:
33 parts by weight of an ultraviolet double bond polymerizable monomer; 23 parts by weight of a rigid double bond polymerizable monomer; 4 parts by weight of a photoinitiator having an absorption peak of 380 nm; 13 parts by weight of an E51 epoxy resin; 8 parts by weight of a thermal curing agent; 13 parts by weight of granules.

13. The seal agent according to claim 1, wherein the material comprises:
38 parts by weight of an ultraviolet double bond polymerizable monomer; 28 parts by weight of a rigid double bond polymerizable monomer; 6 parts by weight of a photoinitiator having an absorption peak of 390 nm; 18 parts by weight of an E51 epoxy resin; 12 parts by weight of a thermal curing agent; 15 parts by weight of granules.

14. A display panel comprising:
a first substrate and a second substrate arranged opposite to each other; and
a seal agent arranged between the first substrate and the second substrate, wherein the seal agent is made of a material comprising:
30 to 40 parts by weight of an ultraviolet double bond polymerizable monomer;
20 to 30 parts by weight of a rigid double bond polymerizable monomer;
1 to 5 parts by weight of a photoinitiator having an absorption peak ranging from 370 to 400 nm;
10 to 20 parts by weight of an E51 epoxy resin;
5 to 15 parts by weight of a thermal curing agent; and
10 to 20 parts by weight of granules.

15. The display panel according to claim 14, wherein the material comprises:
30 parts by weight of an ultraviolet double bond polymerizable monomer; 20 parts by weight of a rigid double bond polymerizable monomer; 1 part by weight of a photoinitiator having an absorption peak of 370 nm; 10 parts by weight of an E51 epoxy resin; 5 parts by weight of a thermal curing agent; 10 parts by weight of granules.

16. The display panel according to claim 14, wherein the material comprises 35 parts by weight of an ultraviolet double bond polymerizable monomer; 25 parts by weight of a rigid double bond polymerizable monomer; 3 parts by weight of a photoinitiator having an absorption peak of 380 nm; 20 parts by weight of an E51 epoxy resin; 15 parts by weight of a thermal curing agent; 20 parts by weight of granules.

17. The display panel according to claim 14, wherein the material comprises 40 parts by weight of an ultraviolet double bond polymerizable monomer; 30 parts by weight of a rigid double bond polymerizable monomer; 3 parts by weight of a photoinitiator having an absorption peak of 400 nm; 20 parts by weight of an E51 epoxy resin; 15 parts by weight of a thermal curing agent; 20 parts by weight of granules.

18. The display panel according to claim 14, wherein the material comprises 33 parts by weight of an ultraviolet double bond polymerizable monomer; 23 parts by weight of a rigid double bond polymerizable monomer; 4 parts by weight of a photoinitiator having an absorption peak of 380 nm; 13 parts by weight of an E51 epoxy resin; 8 parts by weight of a thermal curing agent; 13 parts by weight of granules.

19. The display panel according to claim 14, wherein the material comprises 38 parts by weight of an ultraviolet double bond polymerizable monomer; 28 parts by weight of a rigid double bond polymerizable monomer; 6 parts by weight of a photoinitiator having an absorption peak of 390 nm; 18 parts by weight of an E51 epoxy resin; 12 parts by weight of a thermal curing agent; 15 parts by weight of granules.

20. A display device comprising a display panel comprising:
a first substrate and a second substrate arranged opposite to each other; and
a seal agent arranged between the first substrate and the second substrate, wherein the seal agent is made of a material comprising:
30 to 40 parts by weight of an ultraviolet double bond polymerizable monomer;
20 to 30 parts by weight of a rigid double bond polymerizable monomer;
1 to 5 parts by weight of a photoinitiator having an absorption peak ranging from 370 to 400 nm;
10 to 20 parts by weight of an E51 epoxy resin;
5 to 15 parts by weight of a thermal curing agent; and
10 to 20 parts by weight of granules.
